(19) United States
(12) Patent Application Publication
(10) Pub. No.: US 2025/0190776 A1
(43) Pub. Date: Jun. 12, 2025

(54) Method and device for weight adjustment in an optical neural network

(71) Applicant: National University of Singapore, Singapore (SG)

(72) Inventors: Zefeng XU, Singapore (SG); Aaron Voon-Yew Thean, Singapore (SG)

(21) Appl. No.: 18/845,350

(22) PCT Filed: Mar. 10, 2023
(86) PCT No.: PCT/SG2023/050154

§ 371 Date: Sep. 9, 2024

(30) Foreign Application Priority Data
Mar. 15, 2022 (SG) 10202202592T

(51) Int. Cl. G06N 3/067; G02F 1/21; G02F 1/225; G06N 3/084

(52) U.S. Cl. CPC G06N 3/067; G02F 1/212; G02F 1/225; G06N 3/084

(57) ABSTRACT

A device for weight adjustment in an optical neural network is provided. The device includes a first waveguide configured to receive and transmit an input optical signal. The input optical signal is defined by an amplitude and a first wavelength. The device further includes an optical resonator in optical communication with the first waveguide. The optical resonator has a first refractive index and is defined by a first resonance frequency. The amplitude of the input optical signal is modulated by the optical resonator based on the first resonance frequency to obtain a first weighted input optical signal. The device further includes a second waveguide optically coupled with the optical resonator. The second waveguide is configured to transmit a backpropagation optical signal that is defined by a second wavelength. The backpropagation optical signal is partially coupled into the optical resonator to adjust the first resonance frequency to a second resonance frequency. An amplitude of a subsequent input optical signal is modulated by the optical resonator based on the second resonance frequency to obtain a second weighted input optical signal.

### FIELD OF INVENTION

The present invention relates broadly, but not exclusively, to a method and device for weight adjustment in an optical neural network.

### BACKGROUND

Over the past decade, promoted by the advancement of artificial intelligence, the computing landscape has massively changed. Current computing competence reaches the “Von Neumann efficiency wall”, i.e., the limitation on the efficiency of transferring data between the processing unit and the memory unit, thus neuromorphic computing becomes an alternative for interested parties seeking to overcome this limitation. Neuromorphic computing is a computational approach for the mimic of a human brain in information processing. Until now, many companies and research institutes have developed some efficient neuromorphic electronics chip, e.g., TrueNorth by IBM, Loihi by Intel and Tianjic by Tsinghua University. However, the limitations of electronics in high performance computing field still result in the widening gap between increasing computing requirements and computing competence. For example, it is difficult to increase the density of neurons and scale of synapsis, it suffers from high energy consumption in large-scale electronics, and its clock rate is unable to exceed a few MHz.

Photonics exhibit excellent performance that can overcome the limitations of conventional neuromorphic electronics. For example, Wavelength Division Multiplexing (WDM) can easily achieve large interconnection density without crosstalk, there is almost no heat loss for data transport and its working frequency and computing speed are much higher than electronics. The main task in photonics neuromorphic computing is exploring the photonics architecture to perform the “neuron” function. Currently there are two conventional methods to serve “weighting” basic function in photonics neuron: one uses active micro-ring resonator (MRR) with external electrical control while the other uses phase change material (PCM) with light absorption characteristic. However, both implementation approaches have further problems such as inability to break through the speed bottleneck of electronics since they require the precise control from electronics. Moreover, the lack of local/on-chip memory limits their efficiency and scope of application.

### SUMMARY

According to a first aspect of the present invention, there is provided a device for weight adjustment in an optical neural network, comprising:
a first waveguide configured to receive and transmit an input optical signal, wherein the input optical signal is defined by an amplitude and a first wavelength;
an optical resonator in optical communication with the first waveguide, wherein the optical resonator has a first refractive index and is defined by a first resonance frequency, and wherein the amplitude of the input optical signal is modulated by the optical resonator based on the first resonance frequency to obtain a first weighted input optical signal; and
a second waveguide optically coupled with the optical resonator, wherein the second waveguide is configured to transmit a backpropagation optical signal that is defined by a second wavelength, and wherein the backpropagation optical signal is partially coupled into the optical resonator to adjust the first resonance frequency to a second resonance frequency;
   wherein an amplitude of a subsequent input optical signal is modulated by the optical resonator based on the second resonance frequency to obtain a second weighted input optical signal.

The device may comprise an Optical-to-Electrical Converter (OEC) in optical communication to the second waveguide. The OEC may be configured to receive a remaining amount of the backpropagation optical signal that is not coupled into the optical resonator, and the OEC may convert the remaining amount of the backpropagation optical signal into a first electrical signal.

The device may further comprise a volatile memory electrically connected to the OEC and the optical resonator. The volatile memory may be configured to receive and store information corresponding to the first electrical signal.

The device may further comprise a peripheral circuit electrically connected to the volatile memory. The peripheral circuit may be configured to drive an electrical and thermal modulation for the optical resonator based on the stored information corresponding to the first electrical signal to adjust the first refractive index of the optical resonator to a second refractive index.

The adjustment of the first refractive index to the second refractive index may be based on a Plasma Dispersion Effect defined by an equation,

$${n}^{2} = 1 - \frac{{Ne}^{2}}{{m}_{e} {ε}_{0} {ω}^{2}} .$$

In one embodiment, the optical resonator may be a micro-ring resonator, wherein the first resonance frequency may be adjusted to the second resonance frequency based on the first refractive index being adjusted to a second refractive index when the backpropagation optical signal is partially coupled into the optical resonator; and in response to the first refractive index being adjusted to the second refractive index, the first resonance frequency is adjusted to the second resonance frequency.

In another embodiment, the optical resonator may be a Mach-Zehnder Interferometer (MZI), wherein the MZI comprises a phase shifter and wherein the first resonance frequency may be adjusted to the second resonance frequency based on the first refractive index of the phase shifter being adjusted to a second refractive index when the backpropagation optical signal is partially coupled into the first phase shifter; and in response to the first refractive index of the first phase shifter being adjusted to the second refractive index, the first resonance frequency is adjusted to the second resonance frequency.

The first refractive index may be adjusted by the backpropagation optical signal to the second refractive index based on an Optical Kerr effect.

The first and the second weighted input optical signals may be defined by a first and second weight value, respectively.

The modulated amplitude of the first and second weighted input optical signals may represent the first and second weight value, respectively.

According to a second aspect of the present invention, there is provided a method for adjusting weight in an optical neural network, comprising:
receiving, by a first waveguide, an input optical signal, wherein the input optical signal has an amplitude and is defined by a first wavelength;
transmitting the input optical signal from the first waveguide to an optical resonator in optical communication with the first waveguide, wherein the optical resonator has a first refractive index and is defined by a first resonance frequency;
modulating, by the optical resonator, the amplitude of the input optical signal based on the first resonance frequency to obtain a first weighted input optical signal;
transmitting, by a second waveguide that is optically coupled with the optical resonator, a backpropagation optical signal that is defined by a second wavelength;
coupling a partial amount of the backpropagation optical signal into the optical resonator, wherein the backpropagation optical signal is partially coupled into the optical resonator to adjust the first resonance frequency to a second resonance frequency; and
modulating, by the optical resonator, an amplitude of a subsequent input optical signal based on the second resonance frequency to obtain a second weighted input optical signal.

The method may comprise receiving, by an Optical-to-Electrical Converter (OEC) in optical communication with the second waveguide, a remaining amount of the backpropagation optical signal that is not coupled into the optical resonator; and converting, by the OEC, the remaining amount of the backpropagation optical signal into a first electrical signal.

The method may further comprise receiving, by a volatile memory that is electrically connected to the OEC and the optical resonator, the first electrical signal; and storing, by the volatile memory, information corresponding to the first electrical signal.

The method may further comprise driving, by a peripheral circuit that is electrically connected to the volatile memory, an electrical and thermal modulation for the optical resonator based on the stored information corresponding to the first electrical signal; and adjusting, based on the electrical and thermal modulation, the first refractive index of the optical resonator to a second refractive index.

Adjusting, based on the electrical and thermal modulation, the first refractive index to the second refractive index may be based on a Plasma Dispersion Effect defined by an equation,

$${n}^{2} = 1 - \frac{{Ne}^{2}}{{m}_{e} {ε}_{0} {ω}^{2}} .$$

In one embodiment, the optical resonator may a micro-ring resonator wherein adjusting the first resonance frequency to the second resonance frequency comprises: adjusting, by the backpropagation optical signal, the first refractive index to a second refractive index; and in response to the first refractive index being adjusted to the second refractive index, adjusting the first resonance frequency to the second resonance frequency.

In another embodiment, the optical resonator may be a Mach-Zehnder Interferometer (MZI), wherein the MZI comprises a phase shifter and wherein adjusting the first resonance frequency to the second resonance frequency comprises: adjusting, by the backpropagation optical signal, the first refractive index of the phase shifter to a second refractive index; and in response to the first refractive index of the first phase shifter being adjusted to the second refractive index, adjusting the first resonance frequency to the second resonance frequency.

The first refractive index may be adjusted by the backpropagation optical signal to the second refractive index based on an Optical Kerr effect.

The first and the second weighted input optical signals may be defined by a first and second weight value, respectively.

The modulated amplitude of the first and second weighted input optical signals may represent the first and second weight value, respectively.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram of a photonics neuron operation based on a method for weight adjustment in the weighting section, according to an embodiment.

FIG. 2 shows a schematic diagram of a device for weight adjustment in an optical neural network, according to an embodiment.

FIG. 3 shows a schematic diagram of the device for weight adjustment in an optical neural network, according to an embodiment.

FIG. 4 shows an example where the amplitude modulation of an input optical signal changes based on a shift in a resonance of an optical resonator, according to an embodiment.

FIG. 5 shows a schematic diagram of an implementation of the device for weight adjustment in a photonics neurons system, according to an embodiment.

### DETAILED DESCRIPTION

Embodiments will be described, by way of example only, with reference to the drawings. Like reference numerals and characters in the drawings refer to like elements or equivalents.

A photonic neural network has been sought as an alternative solution to surpass the efficiency and speed bottlenecks of electronic neural networks. Photonics Artificial Intelligence (AI) companies and laboratories provide optical chips for neuromorphic computing applications. Although current technology is able to achieve large improvement over traditional electronics architecture, the current technology exhibits several limitations: 1) high power consumption (interconnection, external controls), 2) unable to achieve all-on-chip learning, 3) computation speed limited by a lot of electrical modulation and 4) trained network cannot be stored in the local memory on the chip.

To overcome these limitations, there is provided a method to construct a well-suited architecture to avoid the requirement of external control. The kernel of this method comprises separation of training and inference operations and Optical Kerr Effect based all-optical weights update. The method allows for the possibility of real computation at the speed of light without the limitation of electronics.

The present disclosure relates to a method and device for weight adjustment in an optical neural network which can alleviate the aforementioned limitations of optical chips that are commercially available in the market.

In an implementation, there is provided a method for weight adjustment in an optical neural network using Optical Kerr Effect which supports all-optical training. Compared with classical electronics-added weights, all-optical training takes advantage of ultra-high speed and ultra-low latency in photon transportation. Further, the method allows constructing efficient architectures with low power consumption due to little loss in the photonics components and low interconnection loss. Furthermore, the method uses the Optical Kerr Effect with backpropagation optical signal to update the weight of each photonics neuron without the need for external computer control. Based on the method, neuron architecture can be embedded into the photonics network without complex and long-distance interconnection and external controls. Additionally, the architectures are also compatible with the traditional Complementary Metal-Oxide-Semiconductor, thus it is easy for the method to be applied to large-scale architecture.

In another implementation, the method may comprise the use of a local memory to store the backpropagation modulation light information, which can be accessed randomly for inference process, instead of reading the information from external memory with high latency. The final trained weights are stored in the local memory, hence, it is easy and efficient to use the stored weights to add weights to the input signal in the neuron in the inference process.

In yet another implementation, the method may further comprise the use of a peripheral circuit for the electrical control of micro-ring resonator in terms of thermal modulation and electrical modulation in order to read out the stored weights from the local memory. The former has large-range modulation ability, while the latter has small-range but precise modulation ability.

Embodiments of the present disclosure may also be universal and, in a Plug-and-Play configuration which can potentially enable improvement of many photonics computing architecture or photonics network.

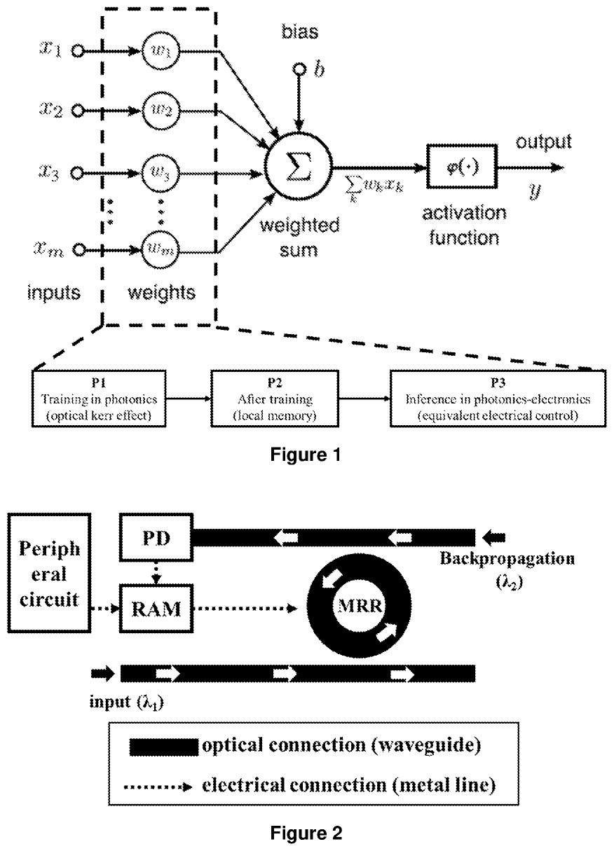

FIG. 1 shows a schematic diagram of a photonics neuron operation based on the method for weight adjustment in an optical neural network, according to an embodiment. As illustrated in FIG. 1, a neuron comprises a dendritic tree that weights the input optical signal from other neurons, a soma that sums up the weighted optical signal and an axon that produces output when the summed signal exceeds a threshold. The method is aimed at the weighting section of neuron, which determines the efficiency and speed of the photonics neuron. The method comprises of three main parts, P1 (training), P2 (local storage of trained model), and P3 (inference).

At P1, Optical Kerr Effect, a non-linear optics effect, is used to add and update weights for the photonics neurons. Specifically, in model training, a feedback/backpropagation optical signal is guided to a weighting unit before modulating the weights. This is a way to update the weights in many training cycles, without any limitation of electronics.

The Optical Kerr Effect is a phenomenon that the light electric field of an incident light induces a refractive index change (Δn) of a medium, which is proportional to the square of the light electric field strength (E) or the light intensity (I). The Optical Kerr Effect may be represented by the following mathematical expression: Δn∝|E|²∝|.

At P2, after the model training, the trained model can be stored in the local/embedded memory. The key information of the trained model is the modulated light at P1, thus the memory needs a device for conversion of optical signal to electrical signal.

At P3, the trained model is used for inference. The trained model can be present by reading out information from the local memory, and the stored weights can be equivalently added to the input optical signals by thermal and electrical modulations (Plasma Dispersion Effect). Such modulations are constant due to the model finished iterations, so the electronics control cannot affect the speed of neuron and the whole network.

Plasma Dispersion Effect is a phenomenon that a refractive index can be changed by manipulating the carrier concentration in a medium, which may be represented by the following equation,

$${n}^{2} = 1 - \frac{{Ne}^{2}}{{m}_{e} {ε}_{0} {ω}^{2}} \qquad ( 1 )$$

where N is the carrier concentration, e is the charge of an electron, me is conductivity effective masses of electron, co is the permittivity of free space, and w is the frequency.

It should be noted that the terms “resonance” and “resonance frequency” are used interchangeably in the following description.

In one embodiment, there is provided a device for weight adjustment in an optical neural network as shown in FIG. 2. In network training, the input light that is defined by wavelength λ1 is guided by a first waveguide and coupled into a micro-ring resonator (MRR). The MRR has a first refractive index and is defined by a first resonance frequency. After the input light is coupled into the MRR, the MRR modulates the amplitude of the coupled input light based on the first resonance frequency. A backpropagation light defined by wavelength λ2 is guided by a second waveguide and couples to the MRR and changes the first refractive index of the medium of MRR to a second refractive index based on Optical Kerr Effect, which causes the first resonance frequency of the MRR to be changed to a second resonance frequency, followed by changing the modulated amplitude of a subsequent input light. A partial amount of the backpropagation light is converted into electrical signal by an Optical to Electrical Convertor (OEC), e.g., photodetector (PD), etc., and the electrical signal is subsequently stored by a volatile memory, e.g., random access memory (RAM), etc. In inference, a peripheral circuit reads out the stored information in the volatile memory and drives the electrical and thermal modulation for the MRR, which achieve equivalent weighting results for λ1 input light.

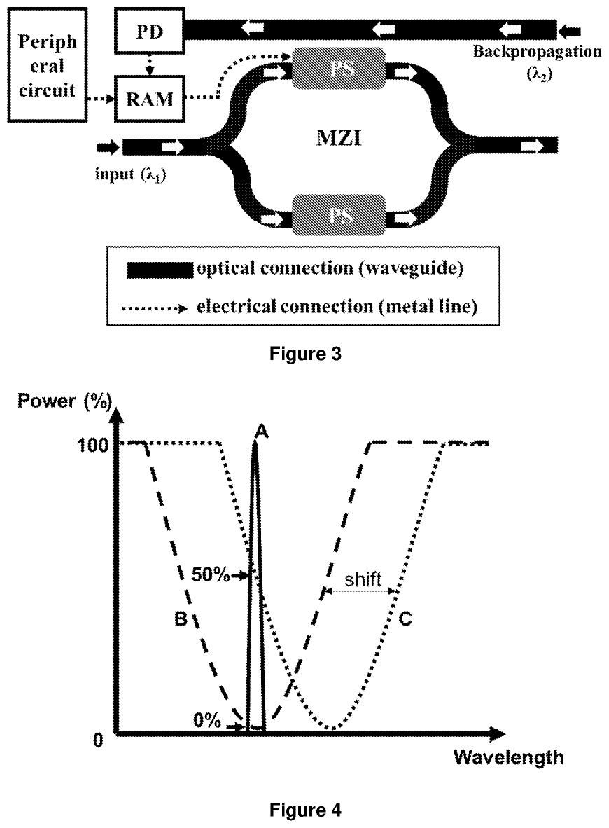

In another embodiment, there is provided a device for weight adjustment in an optical neural network as shown in FIG. 3. In network training, an input light that is defined by wavelength λ1 is guided by a first waveguide through a Mach-Zehnder-interferometer (MZI) comprising a first and second phase shifter (PS) at a first and second arm of the MZI, respectively. The MZI is defined by a first resonance frequency and the first PS having a first refractive index. The MZI modulates the amplitude of the input light based on a first resonance frequency via the PS control. A backpropagation light defined by wavelength λ2 is guided by a second waveguide and couples to the first PS and changes the first refractive index of the medium of the first PS to a second refractive index using Optical Kerr Effect, which shifts the phase in one arm of the MZI and changes the first resonance frequency of the MZI to a second resonance frequency. Afterwards, the MZI changes the modulated amplitude of the subsequent λ1 input light. Some partial of λ2 backpropagation light signal is converted into electrical signal by an Optical to Electrical Converter (OEC), e.g., photodetector (PD), etc., that is stored by a volatile memory, e.g., random access memory (RAM), etc. In inference, a peripheral circuit reads out the stored information in the volatile memory and drives the electrical and thermal modulation for the PS of the MZI, which achieve equivalent weighting results for λ1 input light.

In some embodiments, the backpropagation light may be partially coupled into the optical resonator using an optical splitter with a predetermined splitting ratio. The predetermined splitting ratio may be varied depending on the circuitry of the optical neural network or based on specific applications.

The modulated input light based on the first and second resonance frequencies represent a first and second weighted input light, respectively. Consequently, the first and second weighted input lights are defined by a first and second weight value, respectively.

In some embodiments, the modulated amplitude of the first and second weighted input optical signals represent the first and second weight value, respectively. FIG. 4 shows an example where the amplitude modulation of an input optical signal changes based on a shift in a resonance of an optical resonator, according to an embodiment. In FIG. 4, curve A represents the input light with a center wavelength of λ1 with a small bandwidth (indicated by full width at half-maximum (FWHM)), curve B represents a natural spectrum response of the optical resonator with relatively large bandwidth, and curve C represents a shifted spectrum response of the optical resonator after the refractive index of the optical resonator is altered using the Optical Kerr Effect. The resonance of the optical resonator is at the center of peak in the spectrum response of the optical resonator. Before the shift in the spectrum response of the optical resonator, the resonance of the optical resonator overlaps with the center wavelength of the input light. In this case, almost all or all of the input light are unable to pass through the optical resonator. Hence, the modulation (“weight”) result is 0%. After the shift in the resonance of the optical resonator, the input light overlaps at the 50% point of the resonance peak. In this case, 50% of the input light is able to pass through the modulator. Hence, the modulation (“weight”) result is 50%.

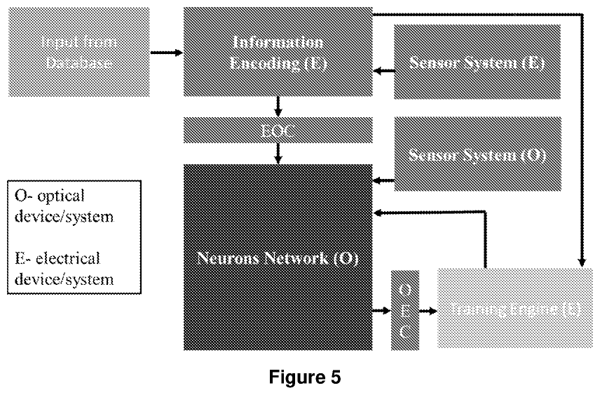

Embodiments of the present disclosure are well-suited for construction of in-situ neuromorphic photonics computing network, which is applicable to many scenarios. As shown in FIG. 5, Optical Neural Network based on the method is capable of processing data from database and sensing data from electrical or optical sensor system, assisted by training engine, electrical-to-optical convertor (EOC) and optical-to-electrical convertor (OEC). Furthermore, the method is possible to be used for the fast optics communication modulation for next generation communication system.

In summary, the method and device according to embodiments of the invention distinguishes itself from the optical chips commercially available in the market, e.g., photonics architecture with external electronics control for neuromorphic computing, through the implementation of all-optical training, local memory and peripheral circuit. All-optical training is made possible by using Optical Kerr Effect to add and update weights of the input light which eliminates the need for any electrical components in the neuron training process. The neuron architecture can, therefore, be embedded into a photonics network without complex and long-distance interconnection and external controls. The local storage stores the trained model and supports on-chip learning. Further, the peripheral circuit reads out the information stored in the local storage and weights the input optical signals via electrical and thermal modulations (Plasma Dispersion Effect) based on the information stored and hence, the speed of the whole network is not limited, since the weights trained are already fixed without the need for any further change.

The following describes the various features and associated technical advantages of embodiments of the invention.

| Feature | Benefit/Advantage |
|---|---|
| All-optical weights | The method according to embodiments of the invention uses |
| update | Optical Kerr Effect to support the all-optical training through |
| | backpropagation. Compared with classical electronics-added |
| | weights, all-optical training takes advantage of ultra-high speed |
| | and ultra-low latency in photon transportation. |
| Low power | The method and device according to embodiments of the |
| consumption | invention allows constructing efficient architectures with low |
| | power consumption due to its little loss in the photonics |
| | components and interconnection loss. |
| Low latency | The method and device according to embodiments of the |
| | invention requires a local memory to store the backpropagation |
| | modulation light information, which can be accessed randomly |
| | for inference process, instead of reading the information from |
| | the external memory with high latency. |
| Ease of large-scale | The architecture according to embodiments of the invention is |
| integration | compatible with the traditional CMOS processes, thus it is easy |
| | for this method to be applied to the large-scale architecture. |
| Fast and accurate | Due to the final trained weights are already stored in the local |
| inference | memory, it is easy and efficient to use stored weights to add |
| | weights to the input signal in the neuron in the inference |
| | process. |
| Support of in-situ | The method and device according to embodiments of the |
| neural network | invention use the Optical Kerr Effect with backpropagation |
| training | optical signal to update the weight each photonics neuron |
| | without the need for external computer control. |
| Support of | The method and device according to embodiments of the |
| continuous learning | invention use the peripheral circuit for the electrical control of |
| | micro-ring resonator in terms of thermal modulation and |
| | electrical modulation. The former has large-range modulation |
| | ability, while the latter has small-range but precise modulation |
| | ability. |
| Ability to be applied | The method and device according to embodiments of the |
| to different | invention can be a universal and Plug-and-Play which enable |
| photonics | improvement of many photonics computing architecture or |
| computing | photonics network potentially. |
| architecture/network | |

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A device for weight adjustment in an optical neural network, comprising:
a first waveguide configured to receive and transmit an input optical signal, wherein the input optical signal is defined by an amplitude and a first wavelength;
an optical resonator in optical communication with the first waveguide, wherein the optical resonator has a first refractive index and is defined by a first resonance frequency, and wherein the amplitude of the input optical signal is modulated by the optical resonator based on the first resonance frequency to obtain a first weighted input optical signal; and
a second waveguide optically coupled with the optical resonator, wherein the second waveguide is configured to transmit a backpropagation optical signal that is defined by a second wavelength, and wherein the backpropagation optical signal is partially coupled into the optical resonator to adjust the first resonance frequency to a second resonance frequency;
wherein an amplitude of a subsequent input optical signal is modulated by the optical resonator based on the second resonance frequency to obtain a second weighted input optical signal.

2. The device of claim 1, further comprising:
an Optical-to-Electrical Converter (OEC) in optical communication to the second waveguide, wherein the OEC is configured to receive a remaining amount of the backpropagation optical signal that is not coupled into the optical resonator, and wherein the OEC converts the remaining amount of the backpropagation optical signal into a first electrical signal.

3. The device of claim 2, further comprising:
a volatile memory electrically connected to the OEC and the optical resonator, wherein the volatile memory is configured to receive and store information corresponding to the first electrical signal.

4. The device of claim 3, further comprising:
a peripheral circuit electrically connected to the volatile memory, wherein the peripheral circuit is configured to drive an electrical and thermal modulation for the optical resonator based on the stored information corresponding to the first electrical signal to adjust the first refractive index of the optical resonator to a second refractive index.

5. The device of claim 4, wherein the peripheral circuit drives the electrical and thermal modulation for the optical resonator based on the stored information corresponding to the first electrical signal to adjust the first refractive index to the second refractive index is based on a Plasma Dispersion Effect defined by an equation,
$${n}^{2} = 1 - \frac{{Ne}^{2}}{{m}_{e} {ε}_{0} {ω}^{2}} .$$

6. The device of claim 1, wherein the optical resonator is a micro-ring resonator.

7. The device of claim 1, wherein to adjust the first resonance frequency to the second resonance frequency comprises:
the first refractive index being adjusted to a second refractive index when the backpropagation optical signal is partially coupled into the optical resonator; and
in response to the first refractive index being adjusted to the second refractive index, the first resonance frequency is adjusted to the second resonance frequency.

8. The device of claim 1, wherein the optical resonator is a Mach-Zehnder Interferometer (MZI), wherein the MZI comprises a phase shifter and wherein to adjust the first resonance frequency to the second resonance frequency comprises:
the first refractive index of the phase shifter being adjusted to a second refractive index when the backpropagation optical signal is partially coupled into the first phase shifter; and
in response to the first refractive index of the first phase shifter being adjusted to the second refractive index, the first resonance frequency is adjusted to the second resonance frequency.

9. The device of claim 7, wherein the backpropagation optical signal adjusts the first refractive index to the second refractive index based on an Optical Kerr effect.

10. The device of claim 1, wherein the first and the second weighted input optical signals are defined by a first and second weight value, respectively.

11. The device of claim 10, wherein the modulated amplitude of the first and second weighted input optical signals represent the first and second weight value, respectively.

12. A method for adjusting weight in an optical neural network, comprising:
receiving, by a first waveguide, an input optical signal, wherein the input optical signal has an amplitude and is defined by a first wavelength;
transmitting the input optical signal from the first waveguide to an optical resonator in optical communication with the first waveguide, wherein the optical resonator has a first refractive index and is defined by a first resonance frequency;
modulating, by the optical resonator, the amplitude of the input optical signal based on the first resonance frequency to obtain a first weighted input optical signal;
transmitting, by a second waveguide that is optically coupled with the optical resonator, a backpropagation optical signal that is defined by a second wavelength;
coupling a partial amount of the backpropagation optical signal into the optical resonator, wherein the backpropagation optical signal is partially coupled into the optical resonator to adjust the first resonance frequency to a second resonance frequency; and
modulating, by the optical resonator, an amplitude of a subsequent input optical signal based on the second resonance frequency to obtain a second weighted input optical signal.

13. The method of claim 12, further comprising:
receiving, by an Optical-to-Electrical Converter (OEC) in optical communication with the second waveguide, a remaining amount of the backpropagation optical signal that is not coupled into the optical resonator; and
converting, by the OEC, the remaining amount of the backpropagation optical signal into a first electrical signal.

14. The method of claim 13, further comprising:
receiving, by a volatile memory that is electrically connected to the OEC and the optical resonator, the first electrical signal; and
storing, by the volatile memory, information corresponding to the first electrical signal.

15. The method of claim 14, further comprising:
driving, by a peripheral circuit that is electrically connected to the volatile memory, an electrical and thermal modulation for the optical resonator based on the stored information corresponding to the first electrical signal; and
adjusting, based on the electrical and thermal modulation, the first refractive index to a second refractive index.

16. The method of claim 15, wherein the adjusting, based on the electrical and thermal modulation, the first refractive index to the second refractive index is based on a Plasma Dispersion Effect defined by an equation,
$${n}^{2} = 1 - \frac{{Ne}^{2}}{{m}_{e} {ε}_{0} {ω}^{2}} .$$

17. The method of claim 12, wherein the optical resonator is a micro-ring resonator.

18. The method of claim 12, wherein adjusting the first resonance frequency to the second resonance frequency comprises:
adjusting, by the backpropagation optical signal, the first refractive index to a second refractive index; and
in response to the first refractive index being adjusted to the second refractive index, adjusting the first resonance frequency to the second resonance frequency.

19. The method of claim 12, wherein the optical resonator is a Mach-Zehnder Interferometer (MZI), wherein the MZI comprises a phase shifter and wherein adjusting the first resonance frequency to the second resonance frequency comprises:
adjusting, by the backpropagation optical signal, the first refractive index of the phase shifter to a second refractive index; and
in response to the first refractive index of the first phase shifter being adjusted to the second refractive index, adjusting the first resonance frequency to the second resonance frequency.

20. The method of claim 18, wherein the adjusting, by the backpropagation optical signal, the first refractive index to the second refractive index is based on an Optical Kerr effect.

21. The method of claim 12, wherein the first and the second weighted input optical signals are defined by a first and second weight value, respectively.

22. The method of claim 21, wherein the modulated amplitude of the first and second weighted input optical signals represent the first and second weight value, respectively.
